(19) United States
(12) Patent Application Publication
(10) Pub. No.: US 2023/0242341 A1
(43) Pub. Date: Aug. 3, 2023

(54) Smart Payload Transfer System

(71) Applicant: Olivier Le Lann, WILDAU (DE)

(72) Inventor: Olivier Le Lann, WILDAU (DE)

(21) Appl. No.: 17/589,411

(22) Filed: Jan. 31, 2022

(51) Int. Cl. B65G 1/137; B64F 1/00; B64D 1/02; B64C 39/02; G06Q 10/08

(52) U.S. Cl. CPC B65G 1/1371; B64F 1/00; B64D 1/02; B64C 39/024; G06Q 10/083; B64C 2201/128

(57) ABSTRACT

A smart payload transfer system is a smart station that enables automated linkage between two segments of automated logistics, namely the aerial segment, where drones carry payloads in the air to save time and distance, and the ground segment, where automated vehicles also known as ground robots, carry the payload on the ground to the end user. In other words, the smart station performs the D2R (Drone to Robot) function allowing autonomous transfers from sky to ground. More specifically, the drone delivers its payload to the smart station which in turn collects the payload and transfers it onto the ground robot. Then the robot delivers it to the end user. To accomplish this, the smart station includes three modules: a landing module, payload management module and robot connection module. An automated and calculated performance of these modules helps with delivery of payloads in a faster and cost-efficient manner.

### FIELD OF THE INVENTION

The present invention relates generally to a payload transfer system. More specifically, the present invention is a drone-to-robot automated transfer station with a smart payload transfer system.

### BACKGROUND OF THE INVENTION

With the rise of demand for automated logistics services, solutions that bring the delivery as close as possible to the recipient, also known as last-mile delivery solutions, increase customer satisfaction and the value of the logistics service. Two segments of automated logistics exist today: the aerial segment, where drones carry payloads in the air to save time and distance, and the ground segment, where automated vehicles also known as ground robots, carry the payload on the ground to the end user. However, a station that provides a linkage between these two segments is a rarity in the current market.

It is an objective of the present invention to provide a smart station that enables automated linkage between these two segments, performing the D2R (Drone to Robot) function allowing autonomous transfers from sky to ground. In other words, the drone delivers its payload to the smart station which in turn collects the payload and transfers it onto the ground robot. Then the robot delivers it to the end user. To accomplish this, the smart station comprises three modules: a landing module, a payload management module, and a robot connection module. An automated and calculated performance of these modules helps with delivery of payloads in a faster and cost-efficient manner.

### BRIEF DESCRIPTION OF THE DRAWINGS

FIG. 1 is a block diagram of the present invention, wherein thinner flowlines represent electrical connections, thicker flowlines represent electronic connections between components, and dashed flow lines represent communicably coupled connections between components of the present invention.

FIG. 2 is a front perspective view of the present invention, wherein a drone with a payload is approaching the transfer station.

FIG. 3 is a front perspective view of the present invention, wherein the landing module is in a closed configuration.

FIG. 4 is a top front perspective view of the landing module, wherein the drone with the payload is approaching the landing platform.

FIG. 5 is a top front perspective view of the inner cavity, wherein the drone has placed the payload on the landing platform, and wherein the housing is not shown to clearly represent the inner components.

FIG. 6 is a front perspective view, wherein the payload and a plurality of arrays within the inner cavity are shown.

FIG. 7 is a top front perspective view, wherein the payload is placed within a storage array.

FIG. 8 is a side perspective view of the present invention, wherein a ground robot is picking up the payload for delivery.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

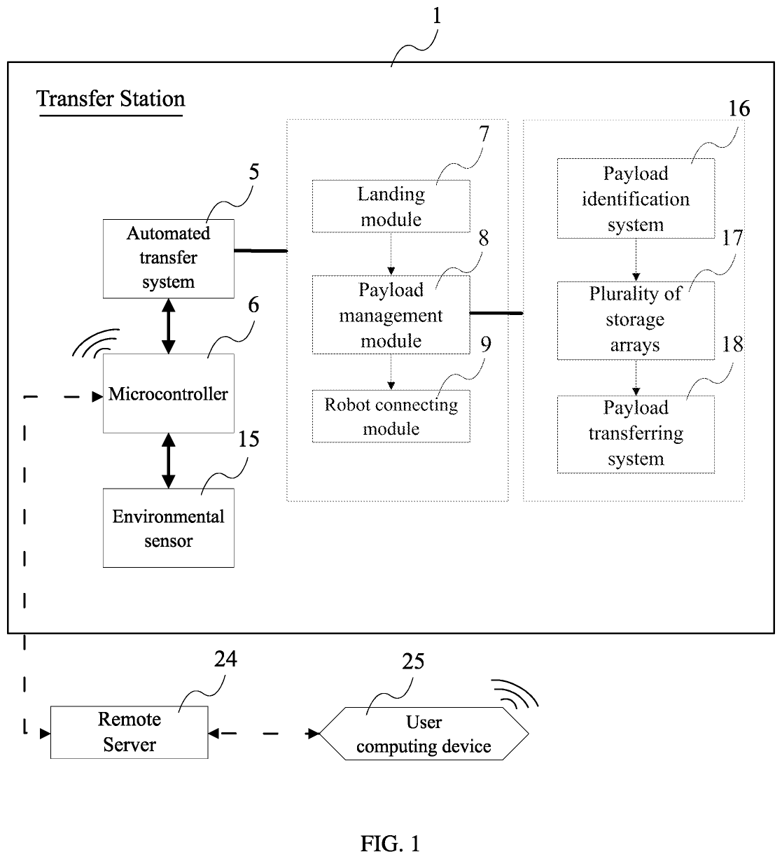

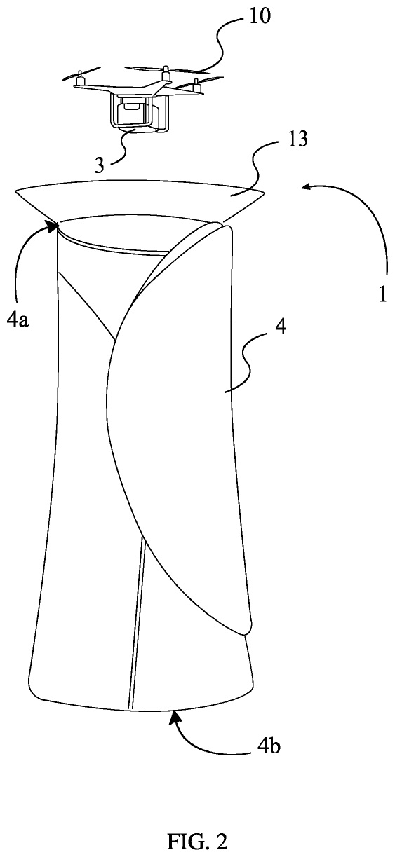

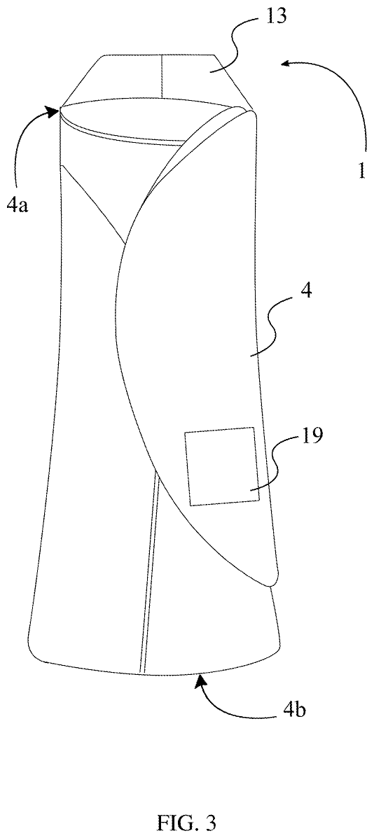

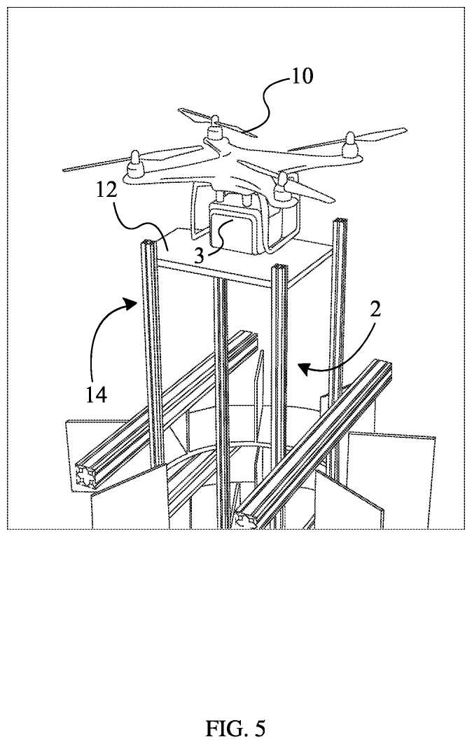

In reference to FIG. 1 through FIG. 5, the present invention is a smart payload transfer system. According to a preferred embodiment, the present invention comprises a transfer station 1, an inner compartment 2, and a payload 3. Preferably, the transfer station 1 comprises all the electrical and mechanical components needed for the smooth functioning of the present invention. In other words, the transfer station 1 comprises the key components and systems that help to accomplish the abovementioned functionalities of the present invention. Further, as seen in FIG. 2, the transfer station 1 comprises a structure with lateral walls, that opens when a drone approaches to facilitate payload drops. The payload 3 is the package that needs to be transferred or stored temporarily with the help of the transfer station, and hence the payload 3 may comprise any size, shape, material, etc. as long as the intents of the present invention are fulfilled. More specifically, the transfer station 1 comprises a housing 4, an automated transfer system 5, and a microcontroller 6. Preferably, the housing 4 is the external structure that houses the components of the present invention. As seen in FIG. 2 and FIG. 3, the housing 4 comprises a tapered cylindrical structure that is approximately three meters in height and is made of a sturdy, weatherproof material. However, the housing 4 may comprise any other size, shape, orientation material, components, and arrangement of components, as long as the intents of the present invention are not altered. For example, the housing 4 may comprise a horizontal structure, wherein a drone delivers a parcel at one end of the horizontal structure and the parcel gets transferred on a moving platform to the other end of the horizontal structure to be delivered to an appropriate receiver. In the preferred embodiment, the inner compartment 2 traverses into the housing 4. In other words, the inner compartment 2 is an internal cavity that helps in containing the various components, and the housing 4 is the protective cover that keeps the components in a safe and secure manner.

According to the preferred embodiment, and in reference to FIG. 1, the automated transfer system 5 comprises a landing module 7, a payload management module 8, and a robot connecting module 9, wherein the three modules together enable in the efficient transfer of the payload within the transfer station 1. Preferably, the automated transfer system 5 is mounted within the inner compartment 2, the landing module 7 is mounted adjacent a first end 4a of the housing 4, and the robot connecting module 9 is mounted adjacent a second end 4b of the housing 4. In the preferred embodiment, the first end 4a constitutes a top end of the housing 4, and the second end 4b constitutes a bottom end of the housing 4. In other words, the second end 4b is positioned opposite to the first end 4a across the housing 4. According to the preferred embodiment, the landing module 7 allows drones to land or drop their payload, and the payload management module 8 identifies, manages, and stores the payloads to be delivered to the customer. Further, the robot connecting module 9 enables user-payload connection or delivery of the payload to the receiver. To accomplish these functions, the payload management module 8 is mounted between the landing module 7 and the robot connecting module 9. Furthermore, to enable smooth functioning and interaction between the various modules and components of the present invention, the microcontroller 6 is electronically connected to the automated transfer system 5. Preferably, the microcontroller 6 is a processing device that manages the operation of the electrical components within the present invention. Thus, with the help of the microcontroller 6, and the different modules that make up the automated transfer system 5, the automated transfer system 5 is operably coupled with the payload 3, wherein controlling the automated transfer system 5 enables movement and temporary storage of the payload 3 within the transfer station 1. In other words, together with all the components and their abovementioned functionalities, the automated transfer system 5 follows an overall method of operation comprising the following steps. Receiving the payload 3 from a drone 10 through the landing module 7, transferring the payload 3 from the landing module 7 to the payload management module 8, and delivering the payload 3 to a ground robot 11 through the robot connecting module 9.

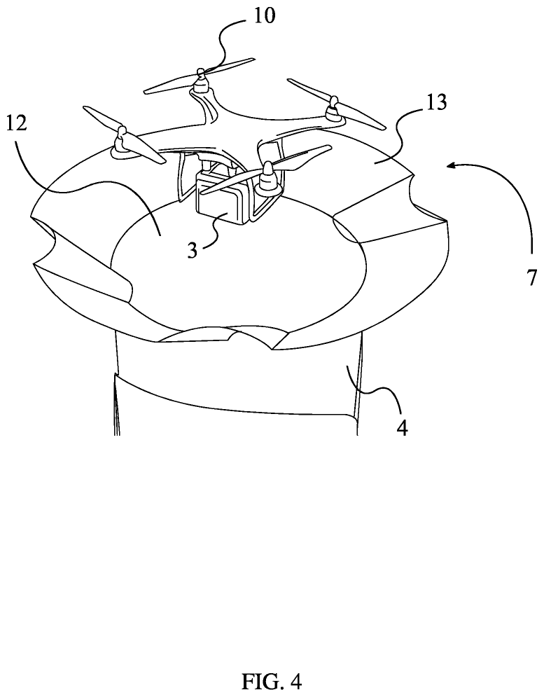

A more detailed description of the various components and their functionalities follow. According to the preferred embodiment, the landing module 7 comprises a landing platform 12, a surrounding wall 13, and a transporting system 14. Preferably, the landing platform 12 is mounted centrally within the housing 4, adjacent the first end 4a of the housing 4. This is so that the landing platform 4a may offer an extendable area located several meters above the ground that acts as a payload dropping area that collects the package. As seen in FIG. 4, the surrounding wall 13 comprises several parts that may be deployed or retracted, that can provide a protective covering for the landing platform 12. More specifically, the surrounding wall 13 is electronically coupled to the microcontroller 6, wherein the surrounding wall 13 transitions between an open configuration and a closed configuration. To accomplish this, the surrounding wall 13 is perimetrically and axially mounted along the first end 4a of the housing 4. As seen in FIG. 2 and FIG. 4, wherein the surrounding wall 13 is in an open configuration, the surrounding wall 13 extends away from the landing platform 12 and the landing platform 12 is exposed and available for an incoming payload 3. As seen in FIG. 3, wherein the surrounding wall 13 is in a closed configuration, the surrounding wall 13 extents (retracts) towards the landing platform 12; and the landing platform 12 is covered by the surrounding wall 13. In the preferred embodiment, the surround wall 13 comprises flat or wavy panels that can move forward and backward. However, the surrounding wall 13 may comprise any other size, shape, components, and arrangement of components that are known to one of ordinary skill in the art, as long as the intents of the present invention are not altered. In order to detect the presence of the drone 10 with the payload 3 and thus activate the opening and closure of the surrounding wall 13, the present invention comprises an environmental sensor 15. Preferably, the environmental sensor 15 is electronically coupled to the microcontroller 6, such that the environmental sensor 15 may continuously monitor an external environment so as to detect the presence of a payload. However, any other detection mechanism that is known to one of ordinary skill in the art may be employed for detecting the payload 3 presence, as long as the intents of the present invention are fulfilled.

According to the preferred embodiment, the transporting system 14 comprises moving components that carry the payload 3 from the landing module 7 and brings the payload 3 to the payload management module 8. Preferably, the transporting system is an elevator. However, the transporting system may comprise any other mechanical system/technology, components, and arrangement of components that are known to one of ordinary skill in the art, as long as the intents of the present invention are not altered. To that end, the transporting system 14 is electronically coupled to the microcontroller 6 and operably coupled to the landing platform 12, such that controlling the transporting system 14 enables rectilinear motion of the landing platform 12 along the housing 4. In other words, the transporting system 14 moves the landing platform 12 up and down along the length of the housing 4, so as to transfer the payload 3 between the various modules.

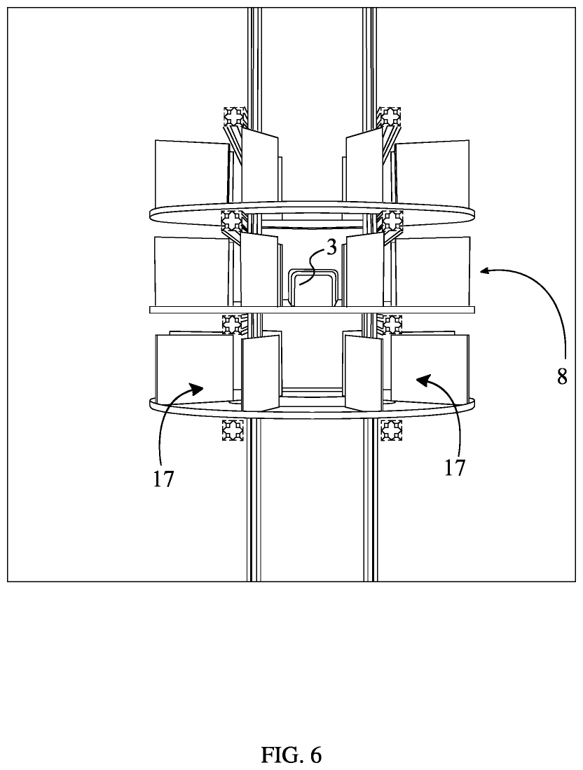

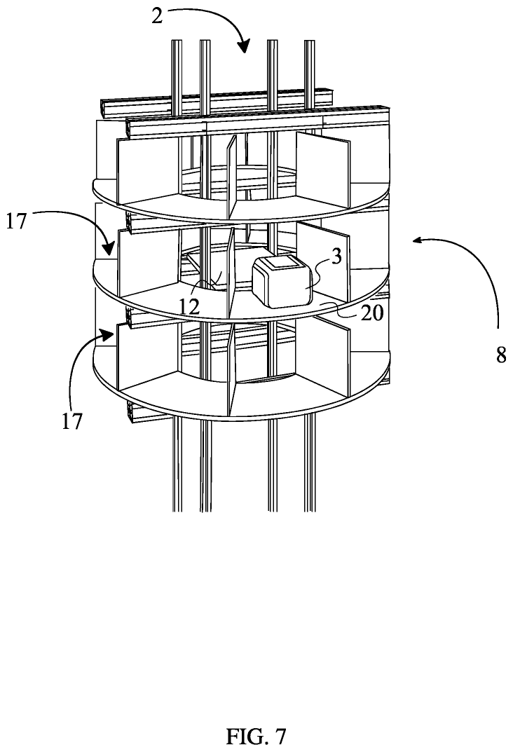

Continuing with the preferred embodiment of the present invention, the payload management module 8 comprises a payload identification system 16, a plurality of storage arrays 17 and a payload transferring system 18. Preferably, the payload identification system 16 identifies an identification label on the payload 3. For example, each of the payload 3 may comprise a specific identification system such as a smart box that includes a bar code, or identification tag that may be decoded with the help of different sensors on the payload identification system 16. Further, the payload 3 may also include a location specific lock system that may be unlocked only by a smart device or phone at the receiver's end. Such a smart locking mechanism will help in the transfer and/or temporary storage of sensitive matter such as documents, test results, medical samples etc. Thus, the payload identification system 16 may identify, categorize, and store different kinds of payloads depending on the industry or category of payloads that the transfer station 1 is catering to. For example, the transfer station 1 may be used by the pharmacy industry/hospital etc. to transfer important files, blood, medicines etc. in a timely and efficient manner. However, the transfer station 1 and hence the payload management module 8 may be customized and catered universally to a wide variety of last-mile delivery solutions. Once the payload 3 has been identified by the payload identification system 16, the payload 3 is transferred to one of the plurality of storage arrays 17 with the payload transfer system 18. As seen in FIG. 6 and FIG. 7, the plurality of storage arrays 17 is laterally arranged within the inner compartment 2 and thus the housing 4. However, the plurality of storage arrays 17 may comprise any other shape, size, location, orientation etc. as long as the intents of the present invention are fulfilled. Furthermore, the payload transfer system 18 may include a mechanism (a robotic hand, slide, belt etc.) that seizes the package and moves it downward into the lower module. In order to help with the identification and sorting, the payload identification system 16 and the payload transferring system 18 are electronically coupled to the microcontroller 6. Hence, it should be noted that the payload identification system 16 and the payload transfer system 18 may comprise any other technology, components, and arrangement of components, as long as the intents of the present invention are not hindered.

According to the preferred embodiment, wherein the payload 3 need not be delivered immediately, the payload 3 is transferred to one of the plurality of storage arrays 17 with the payload transferring system 18, and wherein the payload 3 needs to be delivered immediately, the payload 3 is transferred to the robot connecting module 9 with the payload transferring system 18.

In reference to FIG. 3 and FIG. 7, wherein last mile delivery is being done by a person, the present invention comprises a distribution window 19 and a first delivery platform 20. Preferably, the distribution window 19 laterally traverses into the housing 4. Further, the distribution window 19 is positioned adjacent the second end 4b of the housing 4. This is so that a person may easily access the first delivery platform 20 through the distribution window 19. Additionally, one of the storage arrays 17 may be assigned as the first delivery platform 20, for ease of collection of the package through the distribution window 19. Accordingly, the payload 3 is first received on the first delivery platform 20 from the payload management module 8, followed by delivery of the payload 3 to a person through the distribution window 19 with the help of the payload transferring system 18. It should however be noted that, the first delivery platform 20 and distribution window 19 may comprise any other size, shape, location, components and arrangement of components that are known to one of ordinary skill in the art, as long as the intents of the present invention are fulfilled.

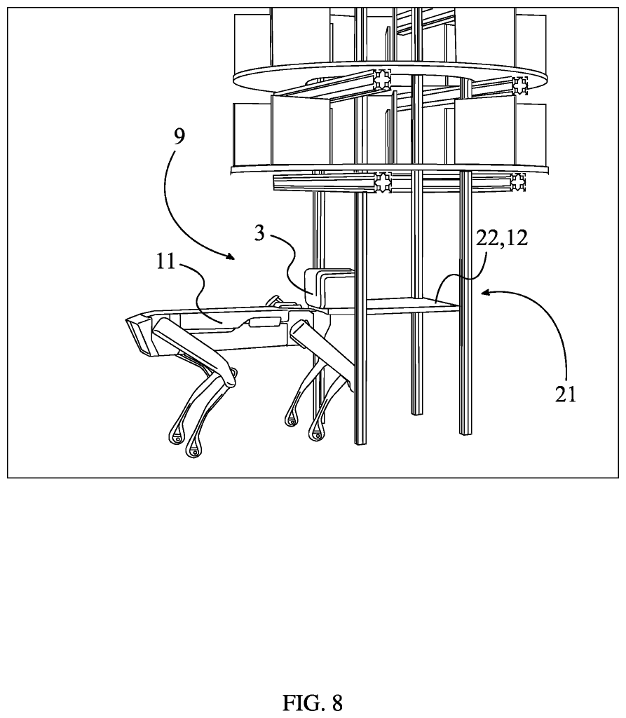

In reference to FIG. 8, wherein last mile delivery is done by a robot, the present invention comprises at least one robot interfacing area 21 and a second delivery platform 22. Preferably, the at least one robot interfacing area 21 is oriented towards a ground opposite to the landing module 7. In other words, the at least one robot interfacing area 21 is positioned adjacent the second end 4b of the housing 4, such that the payload 3 from the payload management module 8 may be received on the second delivery platform 22 and delivered to the ground robot 11 through the at least one robot interfacing area 21. Preferably, the second delivery platform 22 is positioned adjacent the second end 4b of the housing 4 and is easily accessible to the ground robot 11. Further, the second delivery platform 22 may be the landing platform 12 itself, if the landing platform 12 is designed to traverse all the way from the first end 4a towards the second end 4b of the housing. However, it should be noted that the at least one robot interfacing area 21 and the second delivery platform 22 may comprise any other location, position, orientation, components, and arrangement of components that are known to one of ordinary skill in the art, as long as the intents of the present invention are fulfilled.

In order to provide power to the various electrical components of the automated transfer system 5, the present invention comprises a power source 23, wherein the power source 23 is electrically connected to the microcontroller 6. Preferably, the power source 23 is a rechargeable battery, that is mounted within the housing 4. However, the power source 23 may include, but are not limited to, Li ion batteries, magnetic power converters, solar power converters, etc. Further, the transfer station 1 may comprise an electrical terminal that allows the present invention to receive electrical power from an external power supply, and/or an electrical terminal that allows the present invention to send electrical power to an external electrical load.

According to the preferred embodiment, the present invention may be controlled by an operator in charge of the transfer station 1. In other words, the operations of each module of the transfer station 1, the settings of the device etc. may be monitored and/or controlled externally by a user or operator situated in a different location. To accomplish that, the present invention comprises at least one remote server 24 that is communicably coupled to the microcontroller 6, Preferably, the remote server 24 refers to a server computer that is remotely located having a web server software, database and other resources to handle remote requests sent by the users of a website. Furthermore, the user may control, manipulate or operate the automated transfer system 5 with the help of a user computing device 25. Preferably, the user computing device 25 is communicably coupled to the remote server 24, wherein the remote server 24 relays user input from the user computing device 25 to the microcontroller 6. The user computing device 25 may be wirelessly or physically connected to the microcontroller 6. For enabling wireless communication, the microcontroller 6 may comprise a wireless communication module, that connects and communicates with external devices (such as the user computing device) via wireless data transmission protocols. Example standards of what the wireless communication module is capable of using includes, but are not limited to, Bluetooth, WI-FI, GSM, CDMA, ZigBee, etc. This external communication is key for certain sectors such as a medical/pharmaceutical sector that uses the transfer station 1. With this interconnectivity and communication options, medicines may be transferred and/or delivered to different transfer stations based on a GPS location associated on every transfer station. This will enable delivery of payloads in a timely and cost-efficient manner. Alternately, other companies may use the same transfer station 1 and pay the pharmacy a fee for using the facility. Thus, the present invention helps with increasing customer satisfaction and the value of the logistics service.

Although the invention has been explained in relation to its preferred embodiment, it is to be understood that many other possible modifications and variations can be made without departing from the spirit and scope of the invention as hereinafter claimed.

What is claimed is:

1. A payload transfer system connecting a drone to a robot, the system comprising:
a transfer station;
the transfer station comprising a housing, an automated transfer system, and a microcontroller;
an inner compartment;
a payload;
the automated transfer system comprising a landing module, a payload management module, and a robot connecting module;
the inner compartment traversing into the housing;
the automated transfer system being mounted within the inner compartment;
the landing module being mounted adjacent a first end of the housing;
the robot connecting module being mounted adjacent a second end of the housing, wherein the second end is positioned opposite to the first end across the housing;
the payload management module being mounted between the landing module and the robot connecting module;
the microcontroller being electronically connected to the automated transfer system; and
the automated transfer system being operably coupled with the payload, wherein controlling the automated transfer system enables movement and temporary storage of the payload within the transfer station.

2. The payload transfer system as claimed in claim 1, comprising:
receiving the payload from a drone through the landing module;
transferring the payload from the landing module to the payload management module; and
delivering the payload to a robot through the robot connecting module.

3. The payload transfer system as claimed in claim 1, wherein the landing module comprising:
a landing platform;
a surrounding wall;
a transporting system;
the landing platform being mounted centrally within the housing, adjacent the first end of the housing;
the surrounding wall being perimetrically and axially mounted along the first end of the housing;
the surrounding wall and the transporting system being electronically coupled to the microcontroller, wherein the surrounding wall transitions between an open configuration and a closed configuration; and
the transporting system being operably coupled to the landing platform, such that controlling the transporting system enables rectilinear motion of the landing platform along the housing.

4. The payload transfer system as claimed in claim 3, comprising:
wherein the surrounding wall is in an open configuration:
the surrounding wall extending away from the landing platform; and
the landing platform being exposed and available for an incoming payload.

5. The payload transfer system as claimed in claim 3, comprising:
wherein the surrounding wall is in a closed configuration:
the surrounding wall extending towards the landing platform; and
the landing platform being covered by the surrounding wall.

6. The payload transfer system as claim in claim 1, comprising:
an environmental sensor;
the environment sensor being electronically coupled to the microcontroller; and
continuously monitoring an external environment with the environmental sensor in order to detect the presence of a payload.

7. The payload transfer system as claimed in claim 1, wherein the payload management module comprising:
a payload identification system;
a plurality of storage arrays;
a payload transferring system;
the payload identification system identifying an identification label on the payload;
the plurality of storage arrays being laterally arranged within the housing; and
the payload identification system and the payload transferring system being electronically coupled to the microcontroller.

8. The payload transfer system of claim 7, comprising:
wherein the payload need not be delivered immediately:
transferring the payload to one of the plurality of storage arrays with the payload transferring system; and
wherein the payload needs to be delivered immediately:
transferring the payload to the robot connecting module with the payload transferring system.

9. The payload transfer system as claimed in claim 1, the robot connecting module comprising:
wherein last mile delivery is being done by a person:
a distribution window;
a first delivery platform;
the distribution window laterally traversing into the housing;
the distribution window being positioned adjacent the second end of the housing;
receiving the payload to be delivered from the payload management module on the first delivery platform; and
delivering the payload to a person through the distribution window.

10. The payload transfer system as claimed in claim 9, the robot connecting module comprising:
wherein last mile delivery is being done by a robot:
at least one robot interfacing area;
a second delivery platform;
the at least one robot interfacing area being oriented towards a ground opposite to the landing module;
the at least one robot interfacing area being positioned adjacent the second end of the housing;
receiving the payload to be delivered from the payload management module on the second delivery platform; and
delivering the payload to a ground robot through the at least one robot interfacing area.

11. The payload transfer system of claim 1, comprising:
a power source;
the power source being electrically connected to the microcontroller.

12. The payload transfer system as claimed in claim 1 comprising:
at least one remote server; and
the remote server being communicably coupled to the microcontroller, wherein the remote server governs the operation of the automated transfer system.

13. The payload transfer system as claimed in claim 12, comprising:
a user computing device; and
the user computing device being communicably coupled to the remote server, wherein the remote server relays user input from the user computing device to the microcontroller.

14. The payload transfer system of claim 1, wherein the housing being a tapered cylindrical structure.

15. A payload transfer system connecting a drone to a robot, the system comprising:
a transfer station;
the transfer station comprising a housing, an automated transfer system, and a microcontroller;
an inner compartment;
a payload;
the automated transfer system comprising a landing module, a payload management module, and a robot connecting module;
the inner compartment traversing into the housing;
the automated transfer system being mounted within the inner compartment;
the landing module being mounted adjacent a first end of the housing;
the robot connecting module being mounted adjacent a second end of the housing, wherein the second end is positioned opposite to the first end across the housing;
the payload management module being mounted between the landing module and the robot connecting module;
the microcontroller being electronically connected to the automated transfer system;
the automated transfer system being operably coupled with the payload, wherein controlling the automated transfer system enables movement and temporary storage of the payload within the transfer station;
receiving the payload from a drone through the landing module;
transferring the payload from the landing module to the payload management module; and
delivering the payload to a robot through the robot connecting module.

16. The payload transfer system as claim in claim 15, comprising:
an environmental sensor;
the environment sensor being electronically coupled to the microcontroller; and
continuously monitoring an external environment with the environmental sensor in order to detect the presence of a payload.

17. The payload transfer system as claimed in claim 15, wherein the landing module comprising:
a landing platform;
a surrounding wall;
a transporting system;
the landing platform being mounted centrally within the housing, adjacent the first end of the housing;
the surrounding wall being perimetrically and axially mounted along the first end of the housing;
the surrounding wall and the transporting system being electronically coupled to the microcontroller, wherein the surrounding wall transitions between an open configuration and a closed configuration; and
the transporting system being operably coupled to the landing platform, wherein controlling the transporting system enables rectilinear motion of the landing platform along the housing.

18. The payload transfer system as claimed in claim 15, wherein the payload management module comprising:
a payload identification system;
a plurality of storage arrays;
a payload transferring system;
the payload identification system identifying an identification label on the payload;
the plurality of storage arrays being laterally arranged within the housing; and
the payload identification system and the payload transferring system being electronically coupled to the microcontroller.

19. The payload transfer system as claimed in claim 15, the robot connecting module comprising:
wherein last mile delivery is being done by a person:
a distribution window;
a first delivery platform;
the distribution window laterally traversing into the housing;
the distribution window being positioned adjacent the second end of the housing;
the first delivery platform being electronically coupled with the microcontroller;
receiving the payload to be delivered from the payload management module on the first delivery platform; and
delivering the payload to a person through the distribution window.

20. The payload transfer system as claimed in claim 19, the robot connecting module comprising:
wherein last mile delivery is being done by a robot:
at least one robot interfacing area;
a second delivery platform;
the at least one robot interfacing area being oriented towards a ground opposite to the landing module;
the at least one robot interfacing area being positioned adjacent the second end of the housing;
the second delivery platform being electronically coupled with the microcontroller;
receiving the payload to be delivered from the payload management module on the second delivery platform; and
delivering the payload to a ground robot through the at least one robot interfacing area.
